(19) United States
(12) Patent Application Publication
(10) Pub. No.: US 2007/0119403 A1
(43) Pub. Date: May 31, 2007

(54) Device and method for control of an internal combustion engine on a start

(76) Inventor: Jochen Laubender, Stuttgart (DE)

Correspondence Address: Striker Striker & Stenby, 103 East Neck Road, Huntington, NY, 11743, US

(21) Appl. No.: 10/576,434

(22) PCT Filed: Jul. 25, 2005
(86) PCT No.: PCT/EP05/53596

§ 371 Date: Apr. 18, 2006

(30) Foreign Application Priority Data
Jul. 30, 2004 (DE) 10 2004 037 129.6

(51) Int. Cl. F02N 17/00; G06F 19/00; G06G 7/70

(52) U.S. Cl. 123/179.3; 701/113

(57) ABSTRACT

The present invention relates to a method and a device (1) for control of an internal combustion engine (500) at a start, a recording means (420) determining the position of a piston of a cylinder which is beginning compression or entering an intake phase before the start of the internal combustion engine, and a calculation means (410) specifying a starter torque as a function of this piston position.

The present invention is directed to a device for control of an internal combustion engine at a start, according to the general class of the first independent main claim. The present invention also relates to a method for control of an internal combustion engine at a start.

### BACKGROUND INFORMATION

The use of “start-stop” methods to reduce the fuel consumption and emissions of motor vehicles is becoming increasingly common. With current start-stop methods, the engine is started using a stater, such as a belt-starter or a crankshaft integrated-starter-generator, or a typical starter. With a typical start, when the internal combustion engine is run up via fuel injection and subsequent ignition, torque is produced in the internal combustion engine. When the internal combustion engine reaches an adequate speed, the starter is retracted.

Publication EP 0 903 492 A2 makes known a method for controlling a starter-generator, in the case of which the torque output by the starter is adjusted as a function of the starting capability of the internal combustion engine, the starting capability being influenced, e.g., by a temperature of the battery.

Publication EP 1 036 928 A2 makes known a starting device with which, when the internal combustion engine is shut off, at least one cylinder which is beginning compression is identified and, when there is a start request, fuel is injected into this cylinder.

Publication EP 1 270 933 A1 makes known a method for control of starter torque output during the starting procedure of an internal combustion engine coupled with the starter which involves changing over from pure control to regulation with feedback as a function of at least one engine operating parameter. For this purpose, engine speed is monitored during starting and, e.g., when a certain engine speed is reached, a changeover from control to regulation is carried out.

### Advantages of the Invention

In contrast, the device according to the present invention having the features of the independent claim has the advantage that, before the start of the internal combustion engine, a recording means determines the position of a piston of a cylinder which is beginning compression or is entering an intake phase, and a calculation means specifies a starter torque as a function of this piston position before the start of the internal combustion engine.

A further advantage is the corresponding method, according to the present invention, having the features of the corresponding independent claim.

Using the method according to the present invention, it is possible—even before the start of the internal combustion engine, i.e., even before the crankshaft is set into motion—to advantageously specify a starter torque with consideration for the piston position of a relevant cylinder in order to enable an optimum start.

Due to the measures listed in the subclaims, advantageous refinements and improvements of the device described in the independent claim, and of the method described, are made possible.

It is particularly advantageous when the calculation means specifies a course of the starter torque over time as a function of the piston position. Based on a known piston position, it is possible to directly determine the piston positions in all cylinders that occur after a start. It is now advantageously provided to adjust the starter torque over time and based on a crankshaft angle in accordance with the expected piston positions.

It is a further advantage when the calculation means specifies a course of a combustion torque over time as a function of the specified course of the starter torque over time. Since the piston position and the course of the starter torque over time are known and/or specified before the start of the internal combustion engine, the combustion torque can be advantageously specified such that the start takes place in a preferred manner.

According to a further advantageous embodiment, before a start of the internal combustion engine, the calculation means specifies starter and combustion torques for a preferred engine run-up, and, after the start of the internal combustion engine has begun, a control means monitors the engine run-up and, if deviations from the preferred engine run-up are detected, starter and/or combustion torques are adjusted in order to attain the preferred engine run-up. Advantageously, e.g., a preferred engine run-up can be specified before the start, to carry out an optimum start. For example, a preferred engine run-up could take a cold or hot start into consideration or be configured such that auto ignitions of fuel are prevented.

It is furthermore advantageous when the combustion torque is specified, preferably using ignition parameters and/or injection parameters.

A further advantageous embodiment provides that the recording means detects, via a sensor, the absolute angular position of the crankshaft of the internal combustion engine before a start of the internal combustion engine. This has the advantage that synchronization with the crankshaft can take place before the start of the internal combustion engine, so that a large number of variables, controlled variables, settings, etc. can be adjusted at an early stage.

A further advantageous embodiment provides that the calculation means specifies the starter torque such that a fuel injected into the cylinder is distributed homogeneously. The specified starter torque directly influences the rotary speed of the starter and the driven crankshaft and, therefore, piston speed. Piston speed influences, e.g., cylinder-specific combustion chamber pressure gradients and specific flow conditions in the combustion chamber, which can be adjusted such that a homogeneous fuel mixture preferably results.

A further advantageous embodiment provides that the calculation means specifies the starter torque such that auto ignition of the fuel injected into the cylinder is prevented. By influencing the combustion chamber pressure and/or the combustion chamber pressure gradients in a targeted manner via the starter torque, it is advantageously possible to prevent certain courses of pressure over time that are favorable for auto ignition of fuel.

A further advantageous embodiment provides that the calculation means specifies the starter torque such that the starter torque has a local maximum when a piston of a cylinder in the compression phase passes through top dead center. The pressure in the combustion chamber increases sharply, in particular, at the end of the compression phase, in the region of top dead center, and counteracts the starter torque via the gas spring torque that has built up. According to the present invention, it is now advantageously provided to counteract this gas spring torque by increasing the starter torque.

According to a further advantageous embodiment, a calculation means specifies a point in time and/or a crankshaft angle at which the starter is retracted. This makes it possible to retract the starter at the earliest point in time possible, it reduces the mechanical stress on the starter, and increases the comfort of the starting procedure by reducing starter noises or shortening their duration.

According to a further advantageous embodiment, the control means monitors an engine speed and, if a minimum engine speed is exceeded, the starter is retracted, at the latest, when a piston whose cylinder is in a compression phase is at top dead center (ignition TDC). In this case, the minimum engine speed can be selected to be less than a typical starter speed, if it is ensured that the internal combustion engine reaches the necessary speed on its own in the subsequent power cycle. It is then sufficient for the starter to operate, at the most, until top dead center has been reached.

Finally, it is advantageous to provide methods for operating the devices according to the present invention.

### DRAWING

Further features, possible applications and advantages of the present invention result from the description of exemplary embodiments of the present invention, below, the exemplary embodiments being depicted in the drawing. All of the features that are described or depicted, either alone or in any combination, are the subject of the present invention, independent of their wording in the claims or their backward reference, and independent of their wording and/or depiction in the description and the drawing.

FIG. 1 is a schematic illustration of the steps involved in start-stop operation;

FIG. 2 is a schematic illustration of the monitoring of engine run-up;

FIG. 3 is a schematic illustration of an electronic control unit according to the present invention.

### DESCRIPTION

The present invention is based on the premise of specifying a starter torque as a function of a piston position, before the internal combustion engine is started.

It is helpful in particular, with direct-injection internal combustion engines, to determine the piston position of the cylinder which is beginning compression and, with internal combustion engines with manifold injection, to determine the piston position of the cylinder which is entering the intake phase.

To identify the starting cylinder, an absolute angle sensor can be used, for example, which is mounted on the camshaft and/or crankshaft and which senses the instantaneous angular position of the crankshafts. The absolute angle sensor also makes it possible to synchronize the electronic control unit with the internal combustion engine more rapidly than is possible with conventional synchronization methods using reference marks on the crankshaft sensor ring and/or a phase sensor ring on the camshaft.

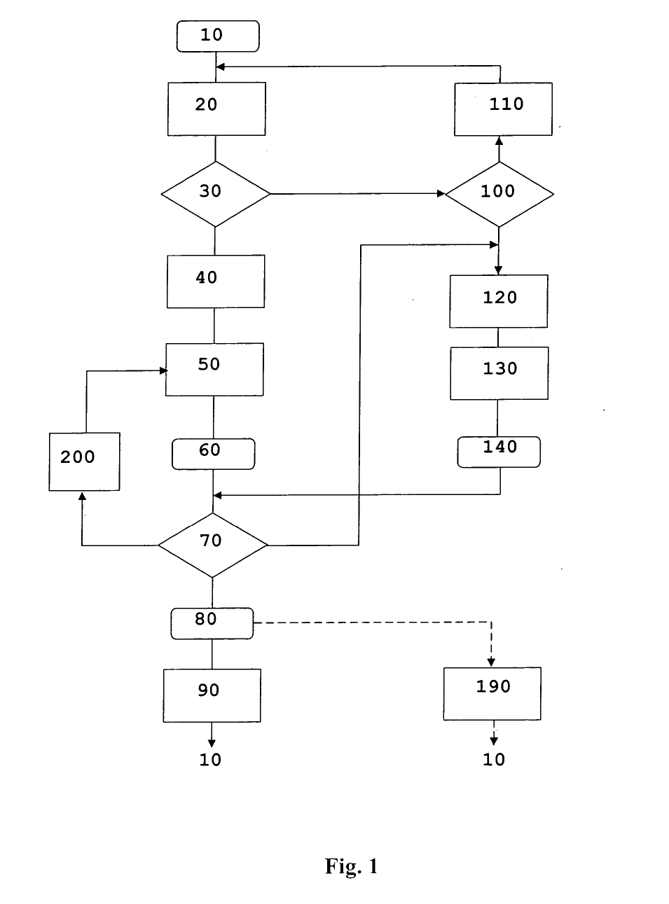

The exemplary embodiment of a start-start operation depicted schematically in FIG. 1 shows an example of a possible application and/or technical field of the present invention.

The exemplary start-stop operation is described as follows: In Step 10, the electronic control unit is in a pre-start phase. In start-stop operation, the ignition (KL15) remains switched on or is energized briefly at defined time intervals, so that the electronic control unit is regularly connected with the supply voltage. As a result, it is no longer necessary to carry out resynchronization of the electronic control unit with the engine at a start, and the various operating parameters of relevant engine functions are updated regularly. As an alternative, this task can also be performed only by a special subfunction in the electronic control unit during the stop phase, thereby alleviating the need to activate the entire electronic control unit every time.

Relevant operating parameters are recorded in Step 20. The following operating parameters can be considered as input variables: Start cylinder, piston position, the temperature of the engine, engine oil, coolant, intake air, ambient air, catalytic converter and fuel, fuel line pressure, ambient air pressure, fuel quality, battery voltage, valve control times, valve lift, compression ratio, gear, clutch, position of the throttle valve, gas pedal or brake pedal, time, etc.

The sensed or determined operating parameters are used to determine, e.g., a start strategy, based on which control variables for an engine run-up are specified. A start strategy can, e.g., take a cold or hot start into account; it can be a start-stop operation, or it can be based thereon in order to realize a rapid engine run-up or to configure an engine run-up such that auto ignition operating states are avoided.

In particular, it can be provided that a starter torque be specified with consideration for a piston position.

In Step 30, a check is carried out to determine whether the start strategy can be implemented. If conditions for the start strategy are unfavorable or are not fulfilled, the procedure branches off to Step 100, where it is determined whether to select a subsequent cylinder in the ignition sequence—Step 100—or whether to initiate an alternative scanning procedure—Step 120.

If the conditions are suitable for implementing the start strategy, relevant control variables are read out in Step 40.

Relevant control variables are, for example: Point of injection, angle of injection, quantity of injection; moment of ignition, angle of ignition; amount of engine. torque to be output; duration—over time or angle—of control of the starter; valve control times, valve lift; compression ratio; throttle valve position, exhaust gas recirculation valve, etc.

In Step 50, the control variables are output to the particular components. The internal combustion engine is started in Step 60.

In subsequent Step 70, a check is preferably carried out after an initial power stroke to determine whether the control variables have resulted in an engine run-up specified according to the start strategy. If deviations occur, the control variables are adjusted in Step 200 such that the desired engine run-up is attained. In Step 50, the new control variables are output to the components. In this cycle, Step 60 is skipped, and another check is carried out in Step 70 to determine whether the engine run-up is taking place in accordance with the start strategy. If deviations occur, the control values are adjusted again in Step 200.

In particular, the starter torques and/or combustion torques can be adjusted for a preferred engine run-up in these steps. The adjustment can be carried out by adapting the control mechanisms or via regulation.

If the start was not successful, during the check carried out in Step 70, the procedure branches off to Step 120, where an alternative start procedure is initiated.

If the start is successful, Step 80 is carried out, in which the internal combustion engine is brought into normal operation.

If a stop request has been issued, the internal combustion engine is stopped in a regulated or unregulated manner, depending on the shutoff concept. When the procedure branches off to Step 90, unregulated engine shutoff is initiated, in the case of which the crankshaft comes to a stop on its own. If regulated engine shutoff is provided, Step 190 follows. Regulated engine shutoff means shutting off an internal combustion engine and, in particular, the crankshaft, in a defined state, so that, in a subsequent start, a piston position that is optimum in terms of start time, fuel consumption, emissions, load on the vehicle electrical system, etc. is attained.

After engine shutoff in Step 90 or 190, the procedure jumpts back to pre-start Step 10, and a new operating cycle can be started.

If Step 30 does not contain conditions for implementing the start strategy, the procedure branches off to Step 100 as described. Preferably, an attempt is carried out to find a cylinder for which the conditions are fulfilled, that is, e.g., the cylinder with a suitable piston position. Step 100 therefore typically branches off initially to Step 110. In this step, a subsequent cylinder in the ignition sequence is selected, and the procedure branches off to Step 20, so that the routine can be carried out again. If a suitable condition is not found in Step 30 this time, either, the loop is typically repeated in Step 100 until all cylinders have been queried. If a suitable condition still does -not exist, Step 100 branches off to Step 120, and an alternative start procedure is initiated.

In Step 120, the current start strategy is aborted. A possible start alternative is to have control variables available for a non-optimized engine run-up. These control variables can be selected such that, e.g., standard values are used for injection and ignition, but the starter can be controlled using control variables for a preferred start strategy, e.g., a start-stop operation. As a further alternative, it can also be provided that a “classical”normal start is implemented, in the case of which the starter is operated in the conventional manner. It can also be provided that certain starter torques are predetermined.

In subsequent Step 130, the control variables are output to the components, after which the start is carried out in Step 140. A check is carried out in Step 70 to determine whether the start was successful.

If the internal combustion engine does not start, the procedure branches from Step 70 back to Step 120, and another start is attempted. If the start fails repeatedly, it can also be provided that suitable error reactions are initiated.

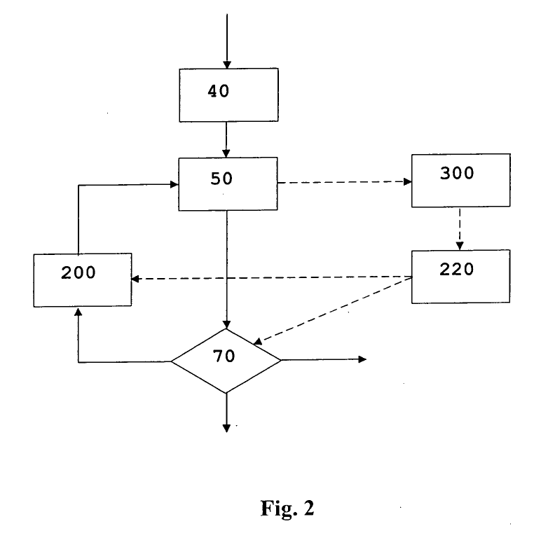

FIG. 2 is a detailed illustration of the steps that take place after the start of the internal combustion engine. As described above with reference to FIG. 1, control values per the start strategy are read out in Step 40 and are output, in Step 50, to components 300 of the internal combustion engine and/or starter 700, and a start takes place in Step 60 (not shown in FIG. 2). After the start begins, and substantially independently of the other steps, operating parameters are read in, e.g., continually or at certain time intervals, in a Step 220, so that a course of relevant operating parameters over time can be determined, if necessary.

After the start begins, a check is carried out in Step 70 with reference to the operating parameters identified in Step 220, to determine whether an engine run-up based on the specified start strategy is being carried out. If the determined operating parameters deviate from the operating parameters expected according to the start strategy, the control variables are adjusted in Step 200 such that the desired engine run-up is attained. In Step 50, the new control values are output to components 300 and stored, if necessary. The success of the adjustments is checked in Step 70. If deviations are found again, the procedure branches back to Step 200.

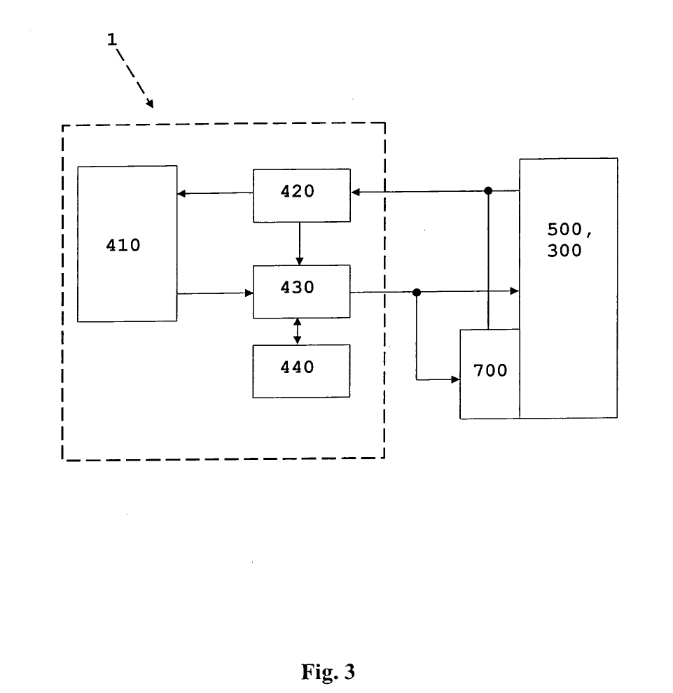

In FIG. 3, the section enclosed by a dashed line shows a device 1 according to the present invention for controlling an internal combustine engine 500, components 300 and a starter 700. Device 1, preferably an electronic control unit, includes a calculation means 410, a recording means 420, and, in the present exemplary embodiment, a control means 430 and a storage means 440.

Recording means 420, preferably a receiver, analog-digital converter or the like, records, e.g., using sensors which are preferably located outside of the device, operating parameters of the internal combustin engine, and forwards related signals to calculation means 410 and control means 430.

Calculation means 410, preferably a microprocessor or, in general, an arithmetic unit, calculates or determines—as a function of the detected operating parameters—a start strategy that is suitable for the start of the internal combustion engine and specifies control variables such that the engine run-up takes place in accordance with the desired start strategy. The control variables and, if applicable, the start strategy, are forwarded to control means 430.

Control means 430 can be configured, e.g., as a separate unit, or it can be part of the functionality of calculation means 410. Using control means 430 and, possibly, other functional modules, components 300 of internal combustion engine 500 and starter 700 are activated with the specified control variables. If control is not provided, the control variables can also be forwarded directly by calculation means 410.

Based on detected operating parameters, control means 430 performs monitoring to determine whether the start of the engine run-up conforms with the specified start strategy. If the engine run-up or certain operating parameters deviate from the parameters expected for the start strategy, control means 430 adjusts the control variables accordingly, to attain an optimum engine run-up in accordance with the desired start strategy. The adjusted and/or adapted control variables are stored in a storage means 440, so that adjusted values are available when another start is carried out using the same start strategy.

To output the control variables according to the start strategy, the control variables can be stored in a storage means 440, e.g., in program maps, characteristic curves, special value tables, memory units of a neuronal network or other memory units, and can be learned adaptively, so that a start that is optimized in terms of time, fuel consumption and emissions is always attained.

Depending on the operating parameters, the optimum start strategy and corresponding control variables are determined and specified, to attain optimum start conditions for the internal combustion engine. If, despite the preselected control variables, optimum operating states still do not occur, e.g., engine vibrations occur, the control variables are selected for the next start in a start-stop operation such that these effects are prevented from reoccurring. It must be ensured, however, that, when the unsuccessful pre-control variables are selected subsequently, 100% reliability of starting is attained, and the pre-control values are adjusted, if necessary.

As an alternative, a changeover to operation with classical starter start (=the starter is rotated for a longer period of time) is carried out. The same applies after a start is aborted or after an unsuccessful start attempt during a start-stop operation.

If, in general, the conditions for a successful “starter-supported direct start”—e.g., after a query into the ambient conditions in the engine before the start—are not completely fulfilled for the relevant start cylinder, e.g., when the piston position of the start cylinder is not optimum, it is possible—by rotating the starter, for example—to move the next cylinder in the ignition sequence from the intake stroke into the compression stroke and to carry out the start routine on this cylinder.

A device and/or electronic control unit according to the present invention containing programmed engine control functionalities makes it possible to output injection and ignition pulses separately and at any points in time and/or crankshaft angles. It also makes it possible to activate an electrical machine, e.g., a starter or a starter-generator, in a time-variable manner, and/or in a manner that is variable with respect to camshaft and/or crankshaft angle. It also makes it possible, in the case of systems with variable compression and/or valve control, to vary the compression ratio and/or the phase and stroke position of the intake and exhaust valves during the start procedure.

With systems with variable valve control, it is also possible—by shifting the valve control times for the intake and exhaust camshaft—to control either the volumetric efficiency in the compression phase or the engine torque that is output. In the compression phase, the volumetric efficiency in the compression cylinder can be changed as a function of the ambient conditions in the engine, e.g., by closing the intake valve late or early.

With regard for regulating the amount of engine torque output to prevent engine vibrations at the start, a portion of the combustion energy can be output into the exhaust port, e.g., by opening the exhaust valve early, in order to effectively reduce the engine torque. Conversely, the control time of the exhaust crankshaft can also be varied in the direction “exhaust valve opens late”, in order to utilize the combustion torque over a greater crankshaft-angle range.

A possible start strategy can provide, e.g., a special regulation algorithm and thereby—e.g., with reference to the compression ratio and/or valve control times—predict or simulate the air mass enclosed in the cylinder, the starting speed, and the course of temperature over time during the compression phase. Accordingly, the output variables of the regulation algorithm and/or the control values can be adjusted such that a temperature which is critical for auto ignition is not exceeded.

With systems with variable compression, it is also possible to vary the compression ratio during the compression and combustion process, in order to thereby control the compression temperature and the compression pressure. If it is determined, e.g., using a temperature or combustion chamber sensor, that the compression temperature and/or compression pressure is too high, the compression in the engine is reduced (=the cylinder is expanded in the direction of increased displacement). If, conversely, the compression temperature and/or compression pressure is too low for optimum mixture preparation, the compression ratio of the engine is increased.

With the method according to the present invention, the problem of auto ignition at high engine temperatures is prevented by coordinating compression, injection and ignition in a targeted manner. By optimizing start activation and combustion, this start variation also offers great potential for shortening start times.

The method according to the present invention makes it possible to base the start strategy and/or engine run-up mainly on two principles: A performance-optimized and, accordingly, torque-optimized activation of a starter, as a start-supporting and/or start-preparing measure, and an optimum control and/or regulation of the initial combustions until the setpoint no-load speed is attained.

The preliminary activation of a starter 700 as a start-supporting measure takes place such that, in the first TDC pass, the starter speed reaches an optimium point for the subsequent combustion. This can mean that the power of starter 700 is controlled—as a function of the piston position in the compression stroke—at the start such that, e.g., the greatest possible engine speed (=kinetic energy and/or torque) is attained in the TDC pass.

This can also mean that the starter can be activated such that a mixture preparation time that is optimal for the subsequent combustion is attained during the compression phase based on the starter speed. This is intended to mean that, e.g., depending on the fuel quality, the temperature of the engine, coolant, and/or oil, the engine compression, etc., the starter speed and resultant piston speed are controlled such that the most homogeneous air-fuel mixture possible forms in the cylinder in the compression phase, the air-fuel mixture being subsequently ignited.

By actively monitoring the combustion chamber temperature using, e.g., a temperature sensor, or by monitoring the course of pressure over time of a combustion chamber sensor, the compression chamber can also be held below the temperature which is critical for auto ignition, for example, by specifically permitting wall heat losses at the cylinder wall to occur during compression.

In both variations, the starter therefore delivers an initial torque, to which the combustion torque generated by the first combustion is subsequently added, resulting in a total engine torque. This ultimately results in the increase in rotational speed during engine run-up. In addition, depending on the start position, the starter is activated in terms of angle or time for only as long as necessary to ensure that the predefined rotational speed is attained when TDC is passed through. This means the starter is actively retracted as soon as possible, to prevent unnecessary loads on the vehicle electrical system and starter noises.

By way of this interplay between optimized starter torque and combustion torque, and optimum starter activation, a very short start time is attained, which makes this system particularly attractive for a start-stop system and, in general, for a faster start of an engine, and is simultaneously a clear “plus” in terms of comfort.

By influencing the starter torque at the start and during engine run-up, it is possible to control the piston speed and piston speed gradients in particular, which results in a large number of influencing possibilities.

As described, it is possible to attain a good mixture preparation in terms of an advantageous Lambda value during the compression or intake phase.

By suitably adjusting the torque, it is possible to keep the load on the vehicle electrical system low during engine run-up. In particular, even before the internal combustion engine is started, the expected load on the vehicle electrical system can be estimated and the power uptake of the starter and, accordingly, the starter torque can be adjusted such that the voltage of the vehicle electrical system does not fall below a critical value and/or a defined threshold during start and engine run-up.

By adjusting the piston speed, it is possible to attain certain combustion chamber pressures, cylinder wall or combustion chamber temperatures, and/or to influence their courses over time. If, e.g., the engine temperature is below a defined temperature threshold, e.g., during a cold start at low temperatures, the combustion chamber temperature required for a desired mixture preparation would not be achieved with a conventional starter and conventional starter speeds, since too much heat would be transferred to the cylinder walls. Using a method according to the present invention, however, it is possible to specifically increase the torque of the starter, e.g., by controlling output, such that, as a result of the piston speed that sets in, the combustion is so rapid that thermal dissipation via the cylinder walls is reduced and the engine reaches the necessary combustion chamber temperature more quickly.

By adjusting the starter torque, it is also possible to avoid certain operating conditions that trigger auto ignition of the enclosed air-fuel mixture. If, e.g., the engine temperature exceeds a certain temperature threshold, at which there is a risk of auto ignition of the air-fuel mixture with a conventional start method, the method according to the present invention makes it possible to slow down the compression process, so that a portion of the compression heat is dissipated via the cylinder walls, which can prevent critical temperatures from being exceeded and can prevent the risk of auto ignition.

In addition, the temperature and pressure in the combustion chamber can be monitored using suitable sensors, and the starter and/or combustion torque and/or engine run-up can be adjusted, controlled or regulated to attain certain operating states.

In addition, certain polytropic exponents can be attained.

The starter speed and starter speed gradients can be adjusted specifically, thereby allowing starting times to be attained that are defined or as short as possible.

It is also feasible to control the starter only for defined time or angular intervals.

It is also possible to deactivate the starter not only via a drop in rotational speed, but also specifically at certain points in time or angular positions.

It can also be provided that the starter be used to set the vehicle in motion and, possibly, to simultaneously start the internal combustion engine.

The vehicle can also be braked using the starter, or it can be used in the sense of an electrical parking brake to keep the vehicle at a standstill.

Further possibilities result when, in addition to the starter torque, the combustion torque is influenced at the start.

The cylinder in the compression stroke is also used as the starting cylinder for the initial combustion, the cylinder in the compression stroke being identified before the start, e.g., using an absolute angle sensor on the crankshaft.

As described, it is also provided to inject fuel into the cylinder and subsequently ignite the air-fuel mixture not primarily before or during the compression phase in the compression cylinder, but only after top dead center has been passed, i.e., when the piston is already located in the expansion phase of the power stroke. As a result, disruptive auto ignitions in the compression phase can be advantageously prevented, for example.

The injection and ignition processes can take place based on time or angle. This starting method can also be used in the second and subsequent combustion processes in the ignition sequence in order to realize a start that is optimized in terms of time, fuel consumption and emissions.

This means, the start routine, as depicted in FIGS. 1 and 2, regulates the parameters (point of injection, quantity of injection, moment of injection) for subsequent combustion, e.g., based on the course of the speed or speed gradient of the previous combustion over time, in order to attain a start that is optimzed in terms of time, fuel consumption and emissions.

By specifically tuning the engine torque (e.g., a smaller quantity of injected fuel, delayed moment of ignition), it is also possible to minimize or prevent engine vibrations that may occur as a result of the initial combustions (=full-load compressions and combustions) and that can be transferred to the passenger compartment, for instance, and be disturbing (=reduced passenger comfort).

Finally, an “overshoot” in the rotational speed above the setpoint no-load speed—which currently occurs mainly during the start procedure—can be reduced, thereby enabling the engine to reach its desired operating state faster. It is essential that the engine reach its desired operating state quickly in start-stop operation so the vehicle can drive away quickly, e.g., after having stopped at a traffic light.

In addition, a reduced number of overshoots in the rotational speed also affects the engine starting noise. A “roaring” of the engine resulting from an excessive rotational speed at the start is therefore effectively suppressed.

As an alternative, the injection and ignition pulses can take place as a function of the input variables and/or operating parameters mentioned above before or during the compression phase, however, i.e., before top dead center is reached. It must be ensured via the input variables (e.g., the temperature of the engine, coolant, oil, intake air temperature, etc.) that any possible auto ignition effects can be reliably ruled out.

As described above, this can be attained, e.g., by activating the starter in a targeted manner, e.g., by monitoring the compression temperature and—via specific wall heat losses at the cylinder wall—holding these thermal losses below a temperature threshold which is critical to auto ignition.

As described, a further alternative is to use an increased injection quantity (=enrichment) for the initial combustions, since this allows the air enclosed in the cylinders to be cooled more (higher enthalpy of evaporation), thereby allowing the temperature in the combustion chamber to be brought below the auto ignition temperature.

The present invention is also suited for use with a start-stop system in motor vehicles with manifold injection, and can also be used in this case for cold starts. The injection pulses must be carried out for the individual cylinders during the intake stroke with the intake valves open, or in the intake manifold with the intake valves closed. It is therefore possible, with these systems as well, to markedly shorten the start time during a hot start, during, e.g., start-stop operation, and during a cold start, and to carry out engine run-up such that it is optimized over time, fuel consumption and emissions.

Due to the injection possibilities, which are limited to the intake stroke, the starter must be activated for a longer period of time in both applications than it is in systems with direct fuel injection. Optimized starter activation can also be achieved in this case.

If the piston of the start cylinder is located in the intake cycle, e.g., close to top dead center with the intake valves open, this cylinder is used for the start. Injection and ignition timing can also be freely selected in this case. Depending on the basic conditions prevailing in the engine, however, (e.g., fuel rail pressure, fuel temperature, etc.), it must be ensured in terms of selecting the point of injection that, while the starter is rotating, all of the quantity of fuel required for stoichiometric combustion—based on the air mass drawn into the cylinder—can be injected into the cylinder before the intake valves close.

To this end, the starter—which is initially located in a start position close to TDC—must be rotated by at least one crankshaft revolution (360° degrees of crankshaft rotation) until the start cylinder has completed its compression cycle and is located in the power stroke.

If the cylinder in the intake stroke is located close to bottom dead center (BDC), or shortly before the end of the intake stroke (=intake closes), so that the time required to inject the necessary quantity of fuel before “intake closes” would not suffice, and any noteworthy turbulence in the cylinder caused by the air drawn in has dissipated, the procedure skips to the next cylinder in the ignition sequence and uses it as the start cylinder, to achieve the advantage of better mixture preparation. This subsequent cylinder must first be moved out of its exhaust stroke and into the intake stroke, which would result in the starter moving by an angle or a time that is greater than one crankshaft revolution (>360° degrees of crankshaft rotation).

In the ideal case, when the start cylinder is located in a central position in the intake stroke (approx. 90° of crankshaft rotation), the angle and/or time that results for starter control is three-fourths of one crankshaft revolution (approx. 270° degrees of crankshaft revolution). The starter is then activated for a slightly longer time than the maximum activation time of the starter of approx. one-half crankshaft revolution (approx. 180° of crankshaft rotation) with gasoline direction-injection systems, with injection taking place during the compression stroke. In this case, the starter is activated in the same manner as it is in systems with direct injection, in order to achieve a start that is optimized in terms of time, fuel consumption and emissions.

The risk of auto ignition occurring at high engine temperatures is prevented in start-stop systems with manifold injection, e.g., by injecting an increased quantity of fuel (enrichment) during the intake stroke or shortly before the intake valves are opened. As a result of the upstream injection in the intake manifold shortly before the intake valves open, or during the intake cycle, the intake air that becomes excessively heated by dissipated engine heat and strong solar influence during, e.g., a stop phase in start-stop operation, cools off via the evaporation of the liquid fuel. The temperature of the air-fuel mixture is therefore reduced markedly and can be kept below the temperature threshold for auto ignition during subsequent compression. In start-stop operation, a worsening of emissions resulting from an increased quantity of injected fuel would be rendered harmless by the catalytic converter, which has already heated up, and would therefore be unproblematic. It must be ensured, however, that the temperature in the catalytic converter does not fall below the conversion temperature, e.g., during a longer stop phase.

What is claimed is:

1. A device (1) for control of an internal combustion engine (500) at a start, wherein
a recording means (420) determines the position of a piston of a first cylinder entering compression or an intake phase before the start of the internal combustion engine, and a calculation means (410) specifies a starter torque as a function of this piston position before the start of the internal combustion engine.

2. The device (1) as recited in claim 1, wherein
the calculation means (410) specifies a course of the starter torque overtime as a function of the piston position.

3. The device (1) as recited in claim 2, wherein
the calculation means specifies a course of a combustion torque over time as a function of the specified course of the starter torque over time.

4. The device (1) as recited in claim 3, wherein,
before a start of the internal combustion engine, the calculation means specifies starter and combustion torques for a preferred engine run-up, and, after the start of the internal combustion engine has begun, a control means (430) monitors the engine run-up and, if deviations from the preferred engine run-up are detected, starter and/or combustion torques are adjusted in order to attain the preferred engine run-up.

5. The device (1) as recited in at least one of the claims claim 3, wherein
the combustion torque is specified by ignition parameters and/or injection parameters.

6. The device (1) as recited in claim 1, wherein
the recording means (420) detects, via a sensor, the absolute angular position of the crankshaft of the internal combustion engine before a start of the internal combustion engine.

7. The device (1) as recited in claim 1, wherein
the calculation means (410) specifies the starter torque such that a fuel injected into the cylinder is distributed homogeneously.

8. The device (1) as recited in claim 1, wherein
the calculation means (410) specifies the starter torque such that auto ignition of the fuel injected into the cylinder is prevented.

9. The device (1) as recited in claim 2, wherein
the calculation means (410) specifies the starter torque such that the starter torque has a local maximum when a piston of a cylinder in the compression stroke passes through top dead center.

10. The device (1) as recited in claim 1, wherein
a calculation means (410) specifies an instant and/or a crankshaft angle at which the starter is retracted.

11. The device (1) as recited in claim 10, wherein
the control means (430) monitors an engine speed and, if a minimum engine speed is exceeded, it retracts the starter, at the latest, when a piston whose cylinder is in the compression stroke is at top dead center.

12. A method for control of an internal combustion engine at a start, wherein,
before the start of the internal combustion engine, a position of a piston of a cylinder which is beginning compression or entering an intake phase is determined, and a starter torque is specified as a function thereof.

13. The method as recited in claim 12, wherein
a course of the starter torque over time is specified as a function of the piston position.

14. The method as recited in claim 13, wherein
controlled variables for a course of a combustion torque over time are specified as a function of the specified course of the starter torque over time.

15. The method as recited in claim 12, wherein,
before a start of the internal combustion engine, starter and combustion torques for a preferred engine run-up are specified, and the engine run-up is monitored when the start of the internal combustion engine begins and, if deviations from the preferred engine run-up are detected, starter and/or combustion torques are adjusted in order to attain the preferred engine run-up.
